(19) United States
(12) Patent Application Publication
(10) Pub. No.: US 2019/0164114 A1
(43) Pub. Date: May 30, 2019

(54) LOCKER MANAGEMENT DEVICE

(71) Applicant: TOYOTA JIDOSHA KABUSHIKI KAISHA, Toyota-shi (JP)

(72) Inventors: Naotoshi KADOTANI, Sunto-gun (JP); Seiji ARAKAWA, Sunto-gun (JP); Junya WATANABE, Sunto-gun (JP)

(73) Assignee: TOYOTA JIDOSHA KABUSHIKI KAISHA, Toyota-shi (JP)

(21) Appl. No.: 16/180,697

(22) Filed: Nov. 5, 2018

(30) Foreign Application Priority Data
Nov. 27, 2017 (JP) 2017-226879

(51) Int. Cl. G06Q 10/08; G07C 9/00; G05D 1/00

(52) U.S. Cl. CPC G06Q 10/083; G05D 1/0212; G05D 1/0088; G07C 9/00817

(57) ABSTRACT

A locker management device includes a management unit configured to manage a usage status of lockers provided in an autonomous driving vehicle, an acquisition unit configured to acquire a user's use-request for the locker, and a vehicle dispatch control unit configured to dispatch the autonomous driving vehicle to the user. The management unit is configured to determine the locker to be used by the user based on the usage status of the lockers and the use-request acquired by the acquisition unit, and the vehicle dispatch control unit is configured to dispatch the autonomous driving vehicle provided with the locker determined by the management unit to the user.

### CROSS-REFERENCE TO RELATED APPLICATION

This application is based on Japanese Patent Application No. 2017-226879 filed with Japan Patent Office on Nov. 27, 2017, the entire contents of which are hereby incorporated by reference.

### TECHNICAL FIELD

The present disclosure relates to a locker management device.

### BACKGROUND

U.S. Pat. No. 9,256,852 discloses a delivery service that uses an autonomous driving vehicle.

### SUMMARY

Incidentally, for example, in some cases in urban areas or tourist spots, the number of coin lockers is not sufficient. When all the coin lockers are in use, a user cannot deposit luggage until there is an empty coin locker. In some cases, the coin lockers are not installed at a place where the user wants to use one. In the present technical field, it is required to improve a convenience for the depositing luggage for the user.

A locker management device according to an aspect of the present disclosure includes a management unit configured to manage a usage status of lockers provided in an autonomous driving vehicle, an acquisition unit configured to acquire a user's use-request for the locker, and a vehicle dispatch control unit configured to dispatch the autonomous driving vehicle to a user. The management unit is configured to determine the locker to be used by the user based on the usage status of the lockers and the use-request acquired by the acquisition unit. The vehicle dispatch control unit is configured to dispatch the autonomous driving vehicle provided with the locker determined by the management unit to the user.

In the locker management device, the locker to be used by the user can be determined by the locker management unit based on the usage status of the lockers and the user's use-request, and the autonomous driving vehicle provided with the determined locker can be dispatched to the user by the vehicle dispatch control unit. As described above, since the locker provided in the autonomous driving vehicle is dispatched to the user, even if there is no empty coin locker, the user can deposit the luggage in the locker provided in the autonomous driving vehicle. Accordingly, the locker management device can improve the convenience of the user's luggage deposit.

In an embodiment, the management unit may provide the user who will use the locker with a release code for releasing the locking of the locker. In this case, only the user to whom the unlock code is provided can use the locker.

In an embodiment, the management unit may manage the locker, a locker capacity, and the usage status of the lockers in association with each other, and determine the locker to be used by the user based on the locker capacity, the usage status of the lockers, and the use-request acquired by the acquisition unit. In this case, the locker management device can determine the locker to be used by the user while considering the locker capacity.

According to various aspects of the present disclosure, a locker management system that can improve the convenience of the user's luggage deposit is provided.

### BRIEF DESCRIPTION OF THE DRAWINGS

FIG. 1 is a diagram illustrating an example of a configuration of a locker management system in an embodiment.

FIG. 2 is a diagram illustrating an example of a hardware configuration of configuration elements of the locker management system.

FIG. 3 is a block diagram illustrating an example of functions of the locker management system.

FIG. 4A and FIG. 4B illustrate examples of data held in a server.

FIG. 5A, FIG. 5B, and FIG. 5C are screen examples of a user device displaying information relating to reservation for a fixed type locker.

FIG. 6A, FIG. 6B, and FIG. 6C are screen examples of the user device displaying information relating to reservation for an autonomous driving locker.

FIG. 7 is a flowchart illustrating an example of locker reservation processing.

FIG. 8A, FIG. 8B, and FIG. 8C are screen examples of a user device displaying information relating to a pickup.

FIG. 9 is a flowchart illustrating an example of reservation processing while considering the pickup.

FIG. 10 is a flowchart illustrating an example of reservation processing

FIG. 11 is a flowchart illustrating an example of luggage reception processing.

FIG. 12 is a flowchart illustrating an example of vehicle dispatch processing.

FIG. 13 is a flowchart illustrating an example of vehicle dispatch processing.

FIG. 14 is a flowchart illustrating an example of vehicle dispatch processing.

FIG. 15 is a flowchart illustrating an example of vehicle dispatch processing.

### DETAILED DESCRIPTION

Hereinafter, exemplary embodiments will be described with reference to the drawings. In the description below, the same reference numerals will be given to the same or equivalent elements, and the description thereof will not be repeated.

### First Embodiment

### Locker Management System

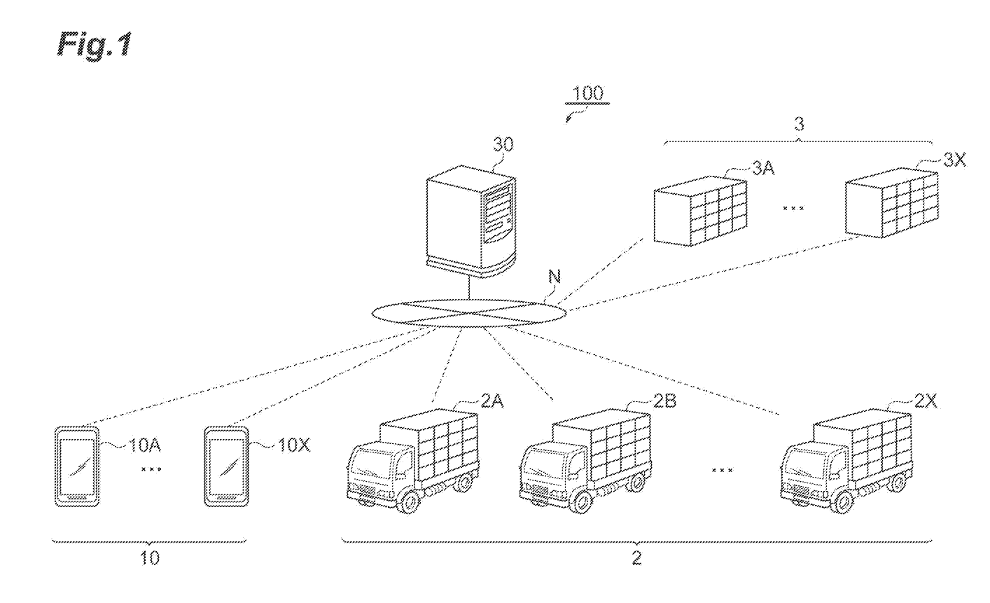

FIG. 1 is a diagram illustrating an example of a configuration of a locker management system in an embodiment. The locker management system provides users with luggage deposit services. As illustrated in FIG. 1, a locker management system 1 includes a plurality of user devices 10A, . . . , 10X, a server 30 (an example of a locker management device), a plurality of vehicles 2A, 2B, . . . , 2X and fixed type lockers 3A . . . 3X.

The plurality of user devices 10A, . . . , 10X are communicably connected to the server 30 via a network N. The network N is, for example, a wireless communication network. The plurality of user devices 10A, . . . , 10X are terminals carried by a user. The user means a user of the locker management system 1. The user may be registered in the locker management system 1 in advance. An ID (user identification number) for identifying the user may be allocated to the registered user. The plurality of user devices 10A, . . . , 10X may have the same configuration. Hereafter, when describing a configuration common to the user devices, the description will be made using a user device 10 as a representative of the user devices.

The plurality of vehicles 2A, 2B, . . . , 2X are communicably connected to the server 30 via the network N. The plurality of vehicles 2A, 2B, . . . 2X are registered in the locker management system 1 in advance. An ID (vehicle identification number) for identifying the vehicle may be allocated to the registered vehicle. The plurality of vehicles 2A, 2B, . . . 2X are autonomous driving vehicles. The autonomous driving vehicle is a vehicle in which an autonomous driving system is mounted, which causes the vehicle to autonomously travel toward a destination set in advance. The autonomous driving vehicle travels autonomously without requiring a driver to perform a driving operation. Hereafter, when describing a configuration common to the vehicles, the description will be made using a vehicle 2 as a representative of the vehicles.

The vehicle 2 includes a locker. The locker is a box that has a locking function and has a space in which luggage or the like can be deposited. As an example, the locker is placed on a cargo bed of the vehicle 2. The locker may be any box as long as the locker has a locking function, for example, may be a cabin of the vehicle 2 or a trunk of the vehicle 2. In addition, a plurality of lockers may be connected to each other vertically or horizontally. Hereinafter, the locker include in the vehicle 2 is referred to as an autonomous driving locker. The autonomous driving locker is registered in the locker management system 1 in advance. An ID (locker identification number) for identifying the locker may be allocated to the registered autonomous driving locker. The vehicle 2 may include a plurality of autonomous driving lockers.

The fixed type lockers 3A, . . . , 3X are communicably connected to the server 30 via the network N. The fixed type lockers 3A, . . . , 3X are usual lockers fixedly installed in facilities and the like. Fixed type lockers 3A, . . . , 3X are registered in the locker management system 1 in advance. An ID (locker identification number) for identifying the locker may be allocated to the registered fixed type locker. Hereinafter, in describing a configuration common to fixed type lockers, the description will be made using the fixed type locker 3 as a representative of the fixed type locker.

The server 30 manages the usage status of the autonomous driving locker and the fixed type locker 3. The usage status is information on whether or not the locker is used. When there is a use-request of the locker from the user via the user device 10, the server 30 determines a locker of either the autonomous driving locker or the fixed type locker 3 based on the usage status of the autonomous driving locker and the fixed type locker 3. Alternatively, the server 30 presents the usage status of the autonomous driving locker and the fixed type locker 3 to the user via the user device 10, and when there is a use-request of the locker from the user via the user device 10, determines a locker of either the autonomous driving locker or the fixed type locker 3 based on the request. When the determined locker is a fixed type locker, the server 30 notifies the user who made the use-request of at least one of the reservation completion and the availability. When the determined locker is an autonomous driving locker, the server 30 dispatches a vehicle 2 including the determined locker to the user who made the use-request.

### Hard Configuration of the Locker Management System

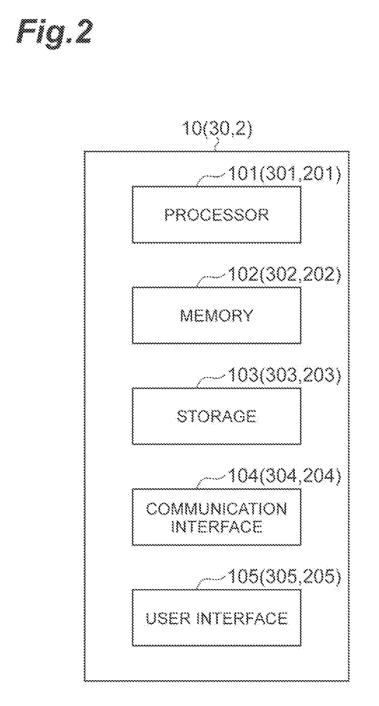

FIG. 2 is a diagram illustrating an example of a hardware configuration of the configuration elements of the locker management system. FIG. 2 illustrates an example of the hardware configuration of the user device 10, the server 30, and the vehicle 2. As illustrated in FIG. 2, the user device 10 includes a processor 101, a memory 102, a storage 103, a communication interface 104, and a user interface 105, and is configured as a general computer.

The processor 101 is an arithmetic unit such as a central processing unit (CPU). The memory 102 is a storage medium such as read only memory (ROM) or random access memory (RAM). The storage 103 is a storage medium such as a hard disk drive (HDD). The communication interface 104 is a communication device that realizes data communication. The user interface 105 is an output device such as a liquid crystal or a speaker, and an input device such as a touch panel or a microphone. The processor 101 performs overall management of the memory 102, the storage 103, the communication interface 104 and the user interface 105, and realizes the function of the user device which will be described later. The user device 10 may have a global positioning system (GPS) receiver.

Similarly to the user device 10 described above, the server 30 includes a processor 301, a memory 302, a storage 303 (an example of a storage unit), a communication interface 304, and a user interface 305. The processor 301 performs overall management of the memory 302, the storage 303, the communication interface 304, and the user interface 305, and realizes the function of the server 30 described later.

The vehicle 2 includes an electronic control unit (ECU). Similarly to the user device 10 described above, the ECU includes a processor 201, a memory 202, a storage 203, a communication interface 204, and a user interface 205. The processor 201 performs overall management of the memory 202, the storage 203, the communication interface 204 and the user interface 205, and realizes the function of the vehicle 2 described later. The vehicle 2 may include a GPS receiver. In addition, the vehicle 2 can include sensors and cameras, which is a general configuration of the autonomous driving vehicles.

### Functional Configuration of the Locker Management System

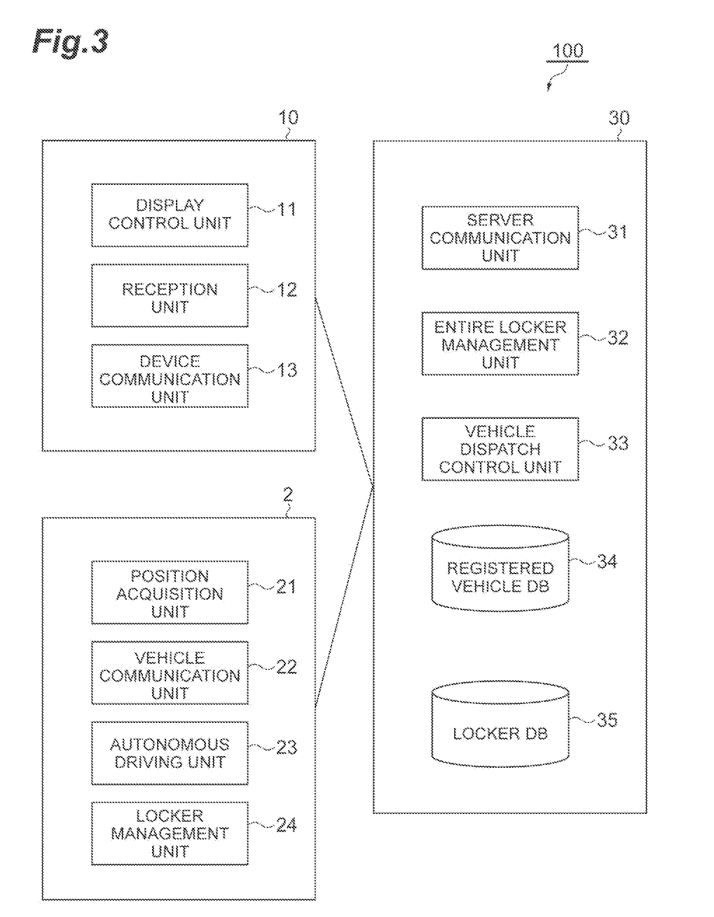

First, a functional configuration of the user device 10 will be described. FIG. 3 is a block diagram illustrating an example of functions of the locker management system 1. As illustrated in FIG. 3, the user device 10 includes a display control unit 11, a reception unit 12, and a terminal communication unit 13.

The display control unit 11 displays a display relating to the luggage deposit service on the user interface 105. The display control unit 11 is realized mainly by the processor 101 operating the user interface 105 while referring to the memory 102 and the storage 103. The information items displayed by the display control unit 11 includes information stored in the memory 102 or the storage 103 in advance, information determined by the user operation received by the reception unit 12, information received from the server 30 by the terminal communication unit 13, and the like.

### Display Relating to a Deposit Position

A deposit position is a position where the user deposits the luggage. The deposit position does not need to coincide with the arrangement position of the locker, but is a position that can be set anywhere. The deposit position may be information that specifies an approximate position or a facility or the like. As an example, the deposit position is specified by the user operation. As an example of a display relating to the luggage deposit service, the display control unit 11 displays a screen supporting the user's input of the deposit position on the user interface 105. For example, the display control unit 11 displays the map on the user, interface 105. A position on which the user performs a tap operation on the map displayed on the user interface 105 of the user device 10 with the finger is the deposit position. The deposit position may be determined based on the position on the GPS receiver provided in the user device 10. The display control unit 11 may display a form for inputting a desired locker capacity, a usage fee, a usage time, and the like on the user interface 105.

### Display of Locker Information

The display control unit 11 displays information relating to the locker as an example of the display relating to the luggage deposit service. The information relating to the locker is, for example, the usage status of the lockers, the attributes of the kicker (for example, the capacity, the usage fee, and the like). As an example, the information relating to the locker is selected based on the deposit position. For example, the information relating to the locker may be information on the fixed type locker 3 existing within a predetermined distance from the deposit position or may be information on an autonomous driving locker that can arrive at the deposit position within a predetermined time.

The display control unit 11 may display a screen for confirming a candidate locker on the user interface 105. As an example, the display control unit 11 displays a map indicating a position of the fixed type locker existing within a predetermined distance from the position of the user device 10 and the current position of the autonomous driving locker that can arrive within a predetermined time, on the user interface 105. When the user performs the tap operation on a candidate locker displayed on the user interface 105 of user device 10 with fingers, the attributes, of the selected candidate locker may be displayed. In addition, when the user performs the tap operation on a candidate locker, the candidate locker selected by the tap operation may be set as a requested locker.

### Display Relating to Intention Confirmation

The display control unit 11 may display a screen for confirming the intention of using the autonomous driving locker on the user interface 105. An example of the confirmation screen is a screen displaying icons selectable by the user operation such as a use button. For example, when the user performs a tap operation on an icon of the use button displayed on the user interface 105 of the user device 10 with the finger, an intention of agreeing to use the autonomous driving locker will be expressed.

### Display Relating to Reservation

The display control unit 11 may display a locker reservation screen on the user interface 105. An example of the reservation screen is a screen displaying icons selectable by user operation such as a reservation button. For example, when the user performs a tap operation on the icons of the reservation button displayed on the user interface 105 of the user device 10, the locker is reserved.

The reception unit 12 receives the user operation relating to the luggage deposit service. The reception unit 12 is realized mainly by the processor 101 operating the user interface 105 while referring to the memory 102 and the storage 103. The user operations relating to the luggage deposit service are, for example, an operation of inputting the deposit position and the attribute of the locker or the like, an operation of selecting a requested locker, an operation of selecting a use button and a reservation button, and the like.

The terminal communication unit 13 communicates with the server 30. The terminal communication unit 13 is realized mainly by the processor 101 operating the communication interface 104 while referring to the memory 102 and the storage 103. The terminal communication unit 13 receives the information relating to the locker from the server 30. As an example, the terminal communication unit 13 receives information necessary for selecting the locker from the server 30 according to the current position of the terminal or the desired deposit position. The information necessary for selecting the locker is, for example, the position of locker, the attributes of the locker, and the like. Furthermore, the terminal communication unit 13 transmits a use-request to the server 30. The use-request is information on a use-request of the locker and includes at least the deposit position. The use-request may include information on a designation of the desired locker, conditions of the desired locker, intention of using the autonomous driving locker expressed by the user, and the like. The terminal communication unit 13 receives details of the reserved locker from the server 30.

In this manner, the information relating to the locker is displayed on the user device 10, and the locker is reserved based on the user operation.

Next, the functional configuration of the server 30 will be described. The server 30 includes a server communication unit 31 (an example of an acquisition unit), an entire locker management unit 32 (an example of a management unit), a vehicle dispatch control unit 33, a registered vehicle DB 34, and a locker DB 35.

First, the data held in the server 30 will be described. The registered vehicle DB 34 stores information relating to the vehicle 2. The registered vehicle DB 34 is stored in the storage 303 of the server 30. The registered vehicle DB 34 stores the vehicle identification number of the vehicle 2 and the information on the vehicle 2 in association with each other.

The locker DB 35 stores information relating to the locker. The locker DB 35 is stored in the storage 303 of the server 30. As an example, the locker DB 35 stores the locker ID and the information relating to the locker in association with each other. The locker ID is an identifier that can specify the locker in the system. As an example, the locker ID is allocated to all of the fixed type locker 3 and the autonomous driving locker.

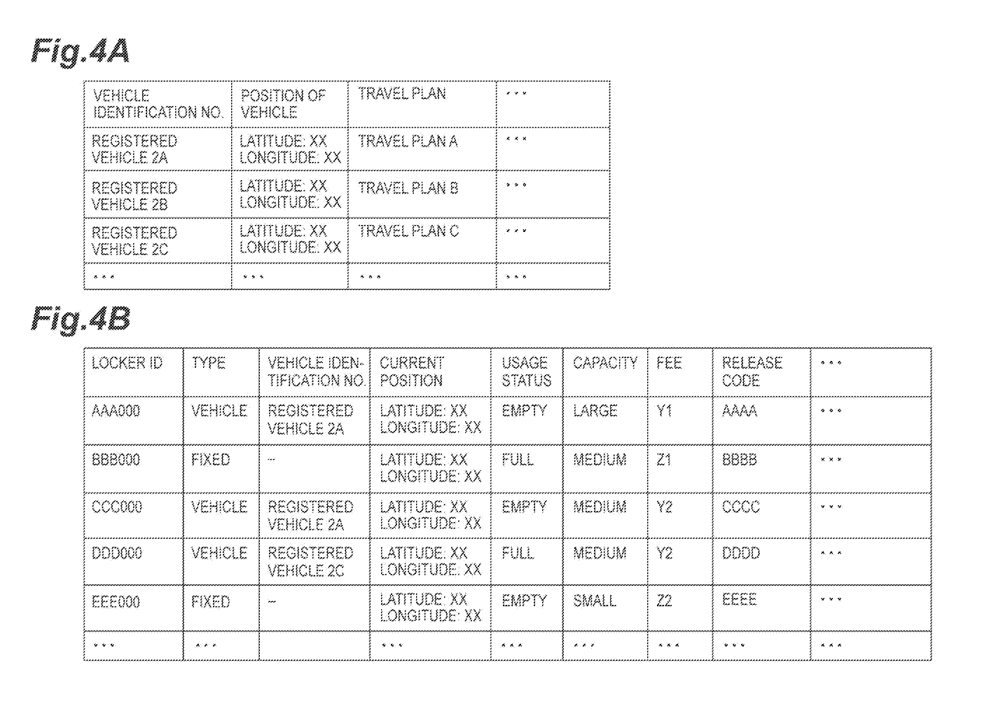

FIG. 4A and FIG. 4B illustrate examples of the data held in the server 30. FIG. 4A is an example of information stored in the registered vehicle DB 34. As illustrated in FIG. 4A, the registered vehicle DB 34 stores a current position of the vehicle, a travel plan, and the like in association with the vehicle identification number. The position of the vehicle is a position on the map, for example, the latitude and the longitude. The travel plan is the dispatch schedule of vehicle 2. The travel plan is data in which the position, speed, destination, and the like of the vehicle 2 are associated with a scheduled time.

In FIG. 4A, a vehicle identification number “registered vehicle 2A”, a position of the vehicle “latitude: XX, longitude: XX”, a travel plan “travel plan A” are stored in association with each other. A vehicle identification number “registered vehicle 2B”, a position of the vehicle “latitude: XX, longitude: XX”, a travel plan “travel plan B” are stored in association with each other. A vehicle identification number “registered vehicle 2C”, a position of the vehicle “latitude: XX, longitude: XX”, a travel plan “travel plan C” are stored in association with each other.

FIG. 4B is an example of the information stored in the locker DB 35. As illustrated in FIG. 4B, the locker DB 35 stores a type, a vehicle identification number, a current position, a usage status, a capacity, a fee, a release code and the like in association with the locker ID. The type is information for identifying the fixed type locker 3 and autonomous driving locker. For example, the type “vehicle” indicates the autonomous driving locker, and the type “fixed” indicates the fixed type locker 3. The vehicle identification number associated with the locker ID is the vehicle identification number of the vehicle 2 that includes the locker. When the vehicle 2 includes a plurality of lockers, the same vehicle identification number is allocated to the locker IDs different from each other. The current position is the location of locker. Of course, in a case of the fixed type locker, the current position is not updated as long as there is no construction or the like. In a case of the autonomous driving locker, the current position is updated at a predetermined timing. The position of the autonomous driving locker coincides with the current position of the vehicle that includes the autonomous driving locker stored in the registered vehicle DB 34. The usage status “empty” indicates that the locker is not in use and is in a reservation available state. The usage status “full” indicates that the locker is in use and is in a reservation unavailable state. The usage status may include a reserved time, scheduled end time of use, and the like. The capacity is a volume inside the locker. The capacity is categorized into three capacities of “large”, “medium” and “small”, but is not limited thereto. The fee is a usage fee, which is the amount paid as the compensation for using the locker. The fee for the autonomous driving locker is set to be cheaper than that for the fixed type locker, but is not limited thereto. The release code is a security code to unlock the locker. The release code may be any information as long as the code is information that functions as a key for only the reserved user can be authenticated. The release code may be any information such as characters, numbers, symbols, images, video images, and the like.

In FIG. 4B, a locker ID “AAA000”, a type “vehicle”, a vehicle identification number “registered vehicle 2A”, a current position “latitude: XX, longitude: XX”, a usage status “empty”, a capacity “large”, a fee “Y1”, a release code “AAAA” are stored in association with each other. A locker ID “BBB000”, a type “fixed”, a vehicle identification number “-”, a current position “latitude: XX, longitude: XX”, a usage status “full”, a capacity “medium”, a fee “Z1”, a release code “BBBB” are stored in association with each other. A locker ID “CCC000”, a type “vehicle”, a vehicle identification number “registered vehicle 2A”, a current position “latitude: XX, longitude: XX”, a usage status “empty”, a capacity “medium”, a fee “Y2”, a release code “CCCC” are stored in association with each other. A locker ID “DDD000”, a type “vehicle”, a vehicle identification number “registered vehicle 2C”, a current position “latitude: XX, longitude: XX”, a usage status “full”, a capacity “medium”, a fee “Y2”, a release code “DDDD” are stored in association with each other. A locker ID “EEE000”, a type “fixed”, a vehicle identification number “-”, a current position “latitude: XX, longitude: XX”, a usage status “empty”, a capacity “small”, a fee “Z2”, a release code “EEEE” are stored in association with each other.

The information in the registered vehicle DB 34 is sequentially updated by the vehicle dispatch control unit 33. That is, the information in the registered vehicle DB 34 is managed by the vehicle dispatch control unit 33. The information in the locker DB 35 is sequentially updated by the entire locker management unit 32. That is, the information in the locker DB 35 is managed by the entire locker management unit 32.

The server communication unit 31 communicates with the user device 10 and the vehicle 2. The server communication unit 31 is realized mainly by the processor 301 operating the communication interface 304 while referring to the memory 302 and the storage 303. The server communication unit 31 acquires the user's use-request for the locker. The user's use-request is acquired via the user device 10.

The entire locker management unit 32 manages the information relating to the lockers and performs overall management of the processing relating to the luggage deposit service. The entire locker management unit 32 is realized mainly by the processor 301 performing arithmetic operations while referring to the memory 302 and the storage 303.

As an example, when the information is received from the vehicle 2 via the server communication unit 31, the entire locker management unit 32 updates the information stored in the locker DB 35. For example, the entire locker management unit 32 updates the current position of the locker stored in the locker DB 35 as necessary.

The entire locker management unit 32 determines the locker to be used by the user based on the usage status of the lockers and the use-request acquired by the server communication unit 31. When the use-request of the locker is received from the user via the user device 10, the entire locker management unit 32 acquires the usage status of the autonomous driving locker and the fixed type locker 3 referring to the locker DB 35. Then, the entire locker management unit 32 determines a locker of either the autonomous driving locker or the fixed type locker 3 based on the usage status of the autonomous driving locker and the fixed type locker 3. Once the locker is determined, the reservation in the server 30 is completed.

When the use-request of the locker is received from the user via the user device 10, the entire locker management unit 32 may present the usage status of the autonomous driving locker and the fixed type locker 3 to the user via the user device 10. When a use-request specifying the desired locker is received from the user via the user device 10, the entire locker management unit 32 determines a locker of either the autonomous driving locker or the fixed type locker 3 based on the use-request.

The autonomous driving locker may be determined by the entire locker management unit 32 based on the usage status of the fixed type locker and/or the user's intention of using the autonomous driving locker of the user. For example, when the number of fixed type lockers in use is equal to or greater than a predetermined value or the number of empty fixed type lockers is equal to or less than a predetermined value, the autonomous driving locker may be determined by the entire locker management unit 32. For example, when the use-request includes an intention of agreeing to use the autonomous driving locker, the autonomous driving locker may be determined by the entire locker management unit 32.

The entire locker management unit 32 may determine the locker to be used by the user based on the locker capacity, the usage status of the lockers, and the user's use-request. When the use-request includes a locker condition (capacity or the like), the entire locker management unit 32 determines an empty locker that matches the locker condition desired by the user.

The entire locker management unit 32 updates the usage status of the lockers based on the result of determining the locker. When the locker is reserved, the entire locker management unit 32 updates the information stored in the locker DB 35. For example, when the locker is reserved, the entire locker management unit 32 updates the usage status of the reserved locker as “full”.

When the use of the locker is ended, the entire locker management unit 32 updates the usage status of the locker as “empty”. When the use of the locker is ended, the entire locker management unit 32 may update the release code of the locker.

The entire locker management unit 32 generates information relating to the luggage deposit service to be displayed on the user device 10. The generated information is transmitted to the user via the server communication unit 31.

The vehicle dispatch control unit 33 dispatches the vehicle 2 that includes the autonomous driving locker determined by the entire locker management unit 32 to the user. The vehicle dispatch control unit 33 transmits the deposit position to the vehicle 2.

Next, a functional configuration of the vehicle 2 will be described. As an example, the vehicle 2 includes a position acquisition unit 21, a vehicle communication unit 22, an autonomous driving unit 23, and a locker management unit 24.

The position acquisition unit 21 acquires the position of the vehicle 2 on the map. The position acquisition unit 21 is realized mainly by the processor 201 operating based on the information obtained from the GPS receiver.

The vehicle communication unit 22 communicates with the server 30. The vehicle communication unit 22 is realized mainly by the processor 201 operating the communication interface 204 while referring to the memory 202 and the storage 203. Transmission information includes information relating to the position of the vehicle 2. Received information includes deposit position. The received information may include information on, the user who made the locker reservation.

The autonomous driving unit 23 causes the vehicle 2 to travel with the autonomous driving. The autonomous driving unit 23 realizes the autonomous driving based on detection information from sensors (not illustrated) or the like and the map information. When the vehicle 2 has an autonomous driving function and travels with the autonomous driving, the received deposit position is set as the destination.

The locker management unit 24 manages the start of use, end of use, locked state, and the like of the autonomous driving locker. When the release code is acquired from the user, the locker management unit 24 releases the autonomous driving locker.

### Examples of Screen

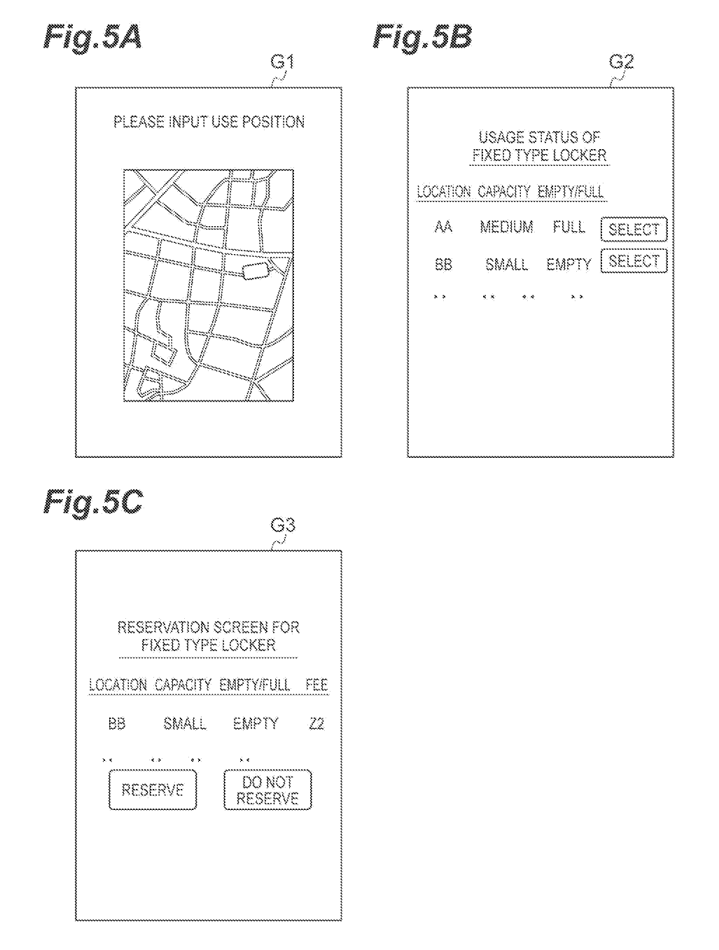

FIG. 5A, FIG. 5B, and FIG. 5C are screen examples of the user device displaying the information relating to the reservation for the fixed type locker. The screen examples illustrated in FIG. 5A, FIG. 5B, and FIG. 5C are displayed by the display control unit 11.

FIG. 5A is a screen example G1 that supports inputting of a use position (deposit position). As illustrated in FIG. 5A, in the screen example G1, a message prompting the user to input the use position and the map are displayed. FIG. 5B is a screen example G2 displaying the usage status of the fixed type locker 3. As illustrated in FIG. 5B, in the screen example G2, the usage status of each fixed type locker 3 selected based on deposit position are displayed. In the screen example G2, the locations and the capacities of the fixed type locker 3 are also displayed. In the screen example G2, selection icons capable of selecting the fixed type locker 3 are further displayed. FIG. 5C is a screen example G3 displaying a reservation screen of the fixed type locker 3. As illustrated in FIG. 5C, in the screen example G3, detailed information (fee) of the fixed type locker 3 selected by the selection icon in the screen example G2 is displayed, and an icon of the reservation button and an icon of the cancellation button (an icon for determining not to reserve) are displayed. The user can make the reservation for the fixed type locker 3 by operating the screen examples G1, G2, and G3. In the screen example G3, the fee may not be presented.

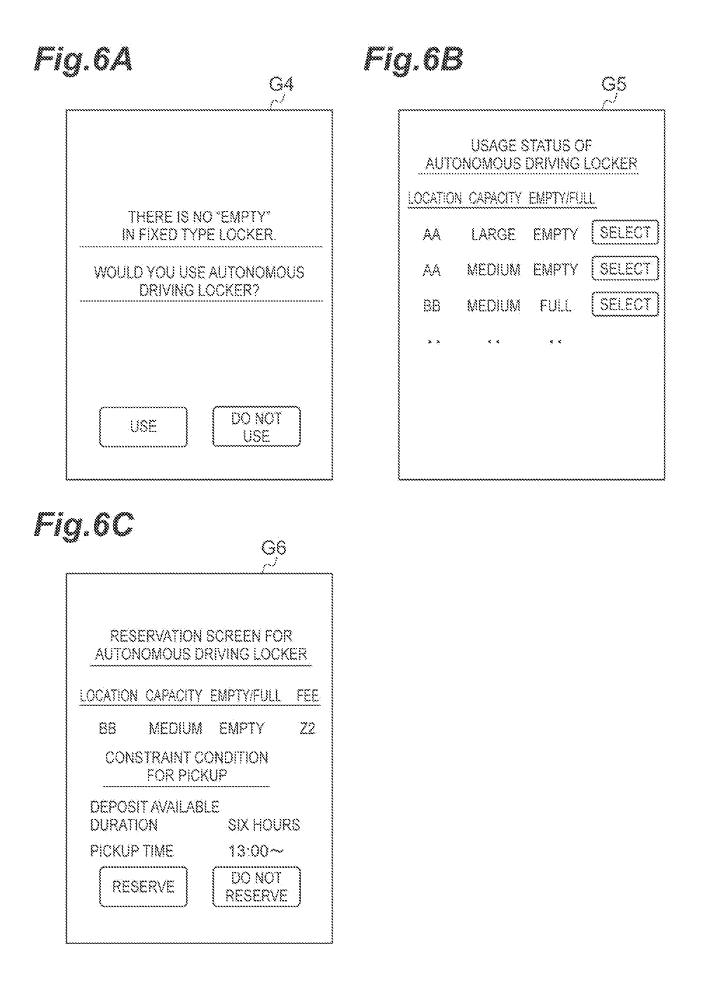

FIG. 6A, FIG. 6B, and FIG. 6C are screen examples of the user device displaying the information relating to the reservation for the autonomous driving locker. The screen examples illustrated in FIG. 6A, FIG. 6B, and FIG. 6C are displayed by the display control unit 11.

FIG. 6A is a screen example G4 for checking the intention of using the autonomous driving locker. As illustrated in FIG. 6A, in the screen example G4, a message asking whether or not to agree to use the autonomous driving locker, an icon of a use button for expressing the intention of using and an icon of a cancellation button for expressing intention of not using are displayed. FIG. 6B is a screen example G5 displaying the usage status of the autonomous driving lockers. As illustrated in FIG. 6B, in the screen example G5, the usage status of each autonomous driving locker selected based on the deposit position are displayed. In the screen example G5, the capacities of the autonomous driving lockers are also displayed. In the screen example G5, selection icons capable of selecting the autonomous driving locker are further displayed. FIG. 6C is a screen example G6 displaying the reservation screen of the autonomous driving locker. As illustrated in FIG. 6C, in the screen example G6, detailed information (fee) of the autonomous driving locker selected by the selection icon in the screen example G5 and constraints conditions (for example, the deposit available duration, the pickup available time) are displayed, and an icon of the reservation button and an icon of the cancellation button (an icon for determining not to reserve) are displayed. The user can make the reservation for the autonomous driving locker by operating the screen examples G4, G5, and G6. In the screen example G6, the fee may not be presented.

### Processing for the Luggage Deposit Service

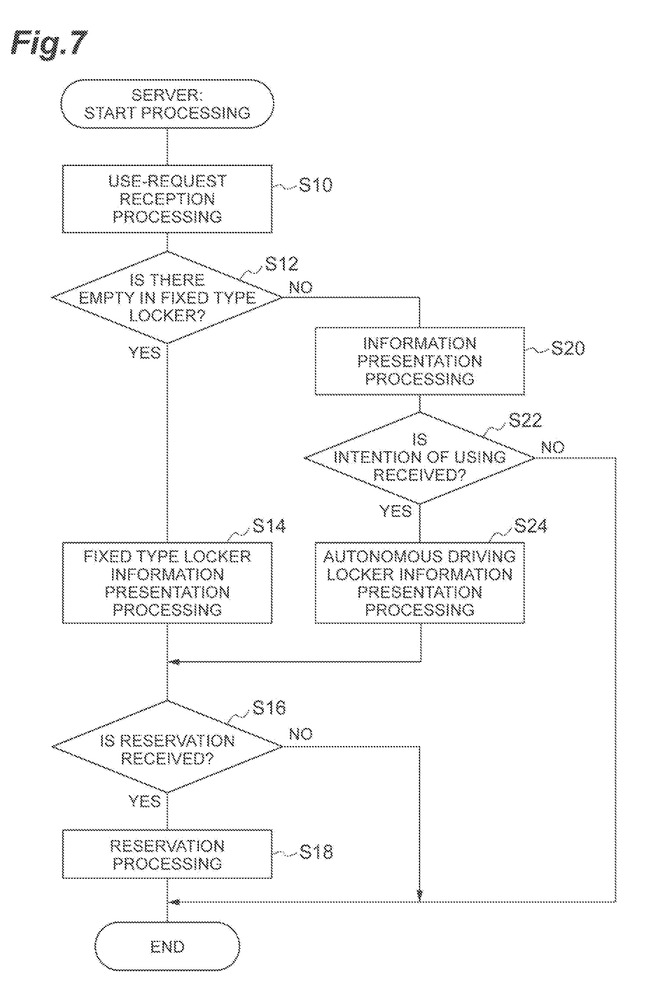

Hereinafter, an example of processing for the luggage deposit service will be disclosed. FIG. 7 is a flowchart illustrating an example of locker reservation processing. The flowchart in FIG. 7 is executed by the server 30. The flowchart in FIG. 7 is executed, for example, at the timing when the user device 10 and the server 30 are in the activation state and when the user activates the luggage deposit application of the user device 10, a the WEB screen of the luggage deposit service, and the like. Before the start of the flowchart in FIG. 7, it is assumed that the server 30 has acquired the position and the usage status of the locker.

As illustrated in FIG. 7, as use-request reception processing (S10), the server communication unit 31 of the server 30 receives a use-request from the user device 10.

Subsequently, as empty fixed type locker 3 determination processing (S12), the entire locker management unit 32 determines whether or not there is an empty fixed type locker that matches the use-request. The entire locker management unit 32 determines the presence or absence of the empty locker based on the deposit position included in the use-request, for example, referring to the locker DB 35.

When it is determined that there is an empty fixed type locker that matches the use-request (YES in S12), as fixed type locker 3 information presentation processing (S14), the entire locker management unit 32 presents information on the empty fixed type locker 3. The entire locker management unit 32 creates, for example, a list of the empty fixed type lockers 3 and transmits the list to the user device 10. For example, the screen example G2 (FIG. 5B) is presented to the user by the user device 10.

When it is determined that there is no empty fixed type locker that matches the use-request (NO in S12), as information presentation processing (S20) for obtaining the agreement, the entire locker management unit 32 presents information proposing to use the autonomous driving locker. The entire locker management unit 32 creates a message indicating that the autonomous driving locker can be used, for example, and transmits the message to the user device 10. For example, the screen example G4 (FIG. 6A) is presented to the user by the user device 10.

Subsequently, as intention of using reception determination processing (S22), the entire locker management unit 32 determines whether or not the user agrees to use the autonomous driving locker. When the use button or the cancellation button icon in the screen example G4 (FIG. 6A) is selected by user, the user device 10 transmits the information on the selected icon to the server 30. When the information indicating that the icon of the use button is selected is received, the entire locker management unit 32 determines that the user agrees to use the autonomous driving locker. When the information indicating that the icon of the cancel button is selected is received, the entire locker management unit 32 determines that the user does not agree to use the autonomous driving locker.

When it is determined that user agrees to use the autonomous driving locker (YES in S22), as autonomous driving locker information presentation processing (S24), the entire locker management unit 32 presents the information on the empty autonomous driving locker. The entire locker management unit 32 creates a list of the empty autonomous driving lockers, for example, and transmits the list to the user device 10. For example, the screen example G5 (FIG. 6B) is presented to the user by the user device 10.

When the fixed type locker 3 information presentation processing (S14) or the autonomous driving locker information presentation processing (S24) ends, as the reservation reception determination processing (S16), the entire locker management unit 32 determines whether or not a reservation is received. In the screen example G3 (FIG. 5C) and the screen example G6 (FIG. 6C), when the icon of the reservation button or the cancellation button is selected by user, the user device 10 transmits the information on the selected icon to the server 30. When the information indicating that the icon of the reservation button is selected is received, the entire locker management unit 32 determines that the reservation is received. When the information indicating that the icon of the cancel button is selected is received, the entire locker management unit 32 determines that the reservation is not received.

When it is determined that the reservation is received (YES in S16), as reservation processing (S18), the entire locker management unit 32 updates the usage status of the locker DB 35 and notifies to the user device 10 of the reservation completion.

When the reservation processing (S18) ends, when it is determined that the reservation is not received (NO in S16), or when it is determined that the user does not agree to use the autonomous driving locker (NO in S22), the flowchart illustrated in FIG. 7 ends. Then, a series of locker reservation processing items ends.

When the autonomous driving locker is reserved, the entire locker management unit 32 outputs vehicle dispatch information including the deposit position to the vehicle dispatch control unit 33. The vehicle dispatch information may include the deposit duration. When the vehicle dispatch information is received from the entire locker management unit 32, the vehicle dispatch control unit 33 dispatches the autonomous driving vehicle 2 to the deposit position.

When the autonomous driving locker is reserved, the entire locker management unit 32 presents the release key of the reserved autonomous driving locker to the user. As a result, the user can release the lock of the autonomous driving locker using the release key.

### Summary of the First Embodiment

In the server 30, the locker to be used by the user can be determined by the entire locker management unit 32 based on the usage status of the lockers and the user's use-request, and the autonomous driving vehicle 2 provided with the determined locker can be dispatched to the user by the vehicle dispatch control unit 33. As described above, since the locker provided in the autonomous driving vehicle 2 is dispatched to the user, even if there is no empty coin locker, the user can deposit the luggage in the locker provided in the vehicle 2. Accordingly, the server 30 can improve the convenience of the user's luggage deposit.

Furthermore, according to the server 30, since only the user who receives the presented release code can use the locker, the security can be insured. The server 30 can determine the locker to be used by user while considering locker capacity. Therefore, the server 30 can further increase the convenience of the user's luggage deposit.

### Second Embodiment

A locker management system in a second embodiment is different from the locker management system 1 in the first embodiment in a point that whether the deposit of the luggage is prioritized or the arrival time of the autonomous driving locker is prioritized is selected by the user, and the locker management system in the second embodiment further has a function of providing a luggage deposit service in accordance with the user's desire, and others are the same as that in the first embodiment. In the second embodiment, the descriptions same as that in the first embodiment will not be repeated.

The entire locker management unit 32 creates a selection screen for causing the user to select whether the deposit of the luggage is prioritized or the arrival time of the autonomous driving locker is prioritized, and presents the screen to the user. When the user selects that the arrival time of the autonomous driving locker is prioritized, the entire locker management unit 32 generates a screen for inputting the pickup position and time, and presents the screen to the user. The pickup position is a position where the user deposits the luggage similar to the deposit position in the first embodiment. The entire locker management unit 32 dispatches the vehicle 2 based on the pickup position and time.

The entire locker management unit 32 may generate a list of candidate vehicles 2 and present the list to the user. In this case, the user selects the desired vehicle 2 from the candidates in the list.

### Screen Example

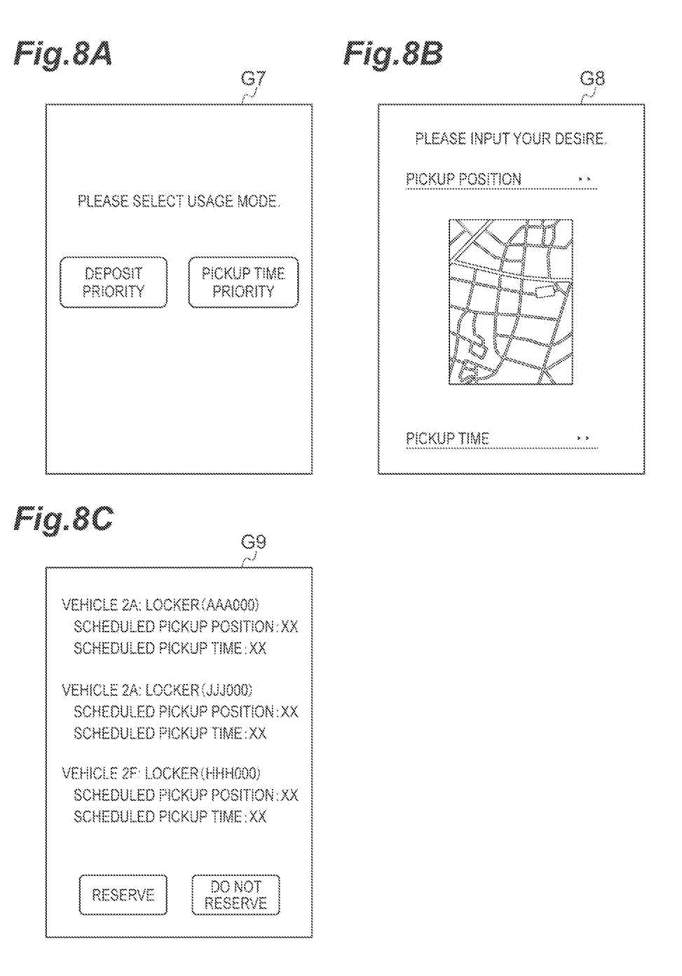

FIG. 8A, FIG. 8B, and FIG. 8C are screen examples of the user device displaying the information relating to the pickup. The screen examples illustrated in FIG. 8A, FIG. 8B, and FIG. 8C are displayed by the display control unit 11.

FIG. 8A is a screen example G7 that supports the selection of a usage mode. As illustrated in FIG. 8A, an icon of a deposit priority button and an icon of a pickup time priority button are displayed on the screen example G7. The deposit priority is to prioritize the deposit of all the luggage and the pickup time priority is to prioritize the time to deposit. FIG. 8B is a screen example G8 that supports inputting of the pickup position and pickup time. The screen example G8 is displayed when the icon of the pickup time priority button is selected in FIG. 8A. As illustrated in FIG. 8B, in the screen example G8, an input form for the pickup position and pickup time and a map that supports the inputting is displayed. FIG. 8C is a screen example G9 displaying the candidate autonomous driving vehicle 2. As illustrated in FIG. 8C, in the screen example G9, a list of the candidate autonomous driving vehicles 2, an icon of a reservation button, and an icon of a cancellation button (an icon for determining not to reserve) are displayed. The user can deposit luggage with the priority on the pickup time by operating on screen examples G7, G8, and G9.

### Reservation Processing Considering Pickup

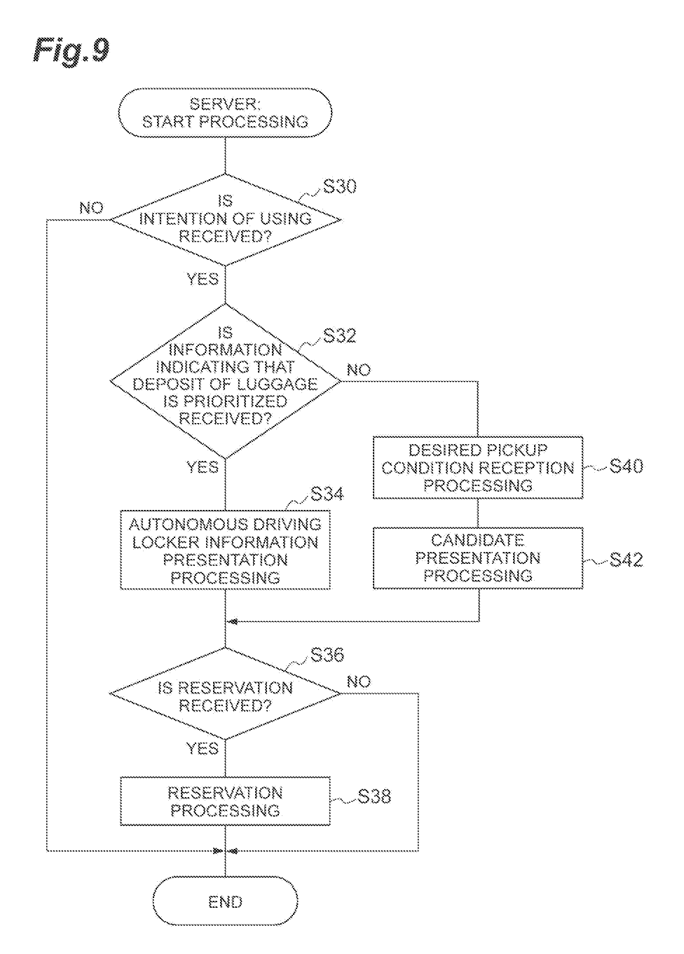

Hereinafter, an example of reservation processing considering the pickup will be disclosed. FIG. 9 is a flowchart illustrating an example of the reservation processing while considering the pickup. The flowchart in FIG. 9 is executed by the server 30. The flowchart in FIG. 9 is executed, for example, at the timing when the user device 10 and the server 30 are in the activation state and the user activates the luggage deposit application of the user device 10, the WEB screen of the luggage deposit service, and the like. Before the start of the flowchart in FIG. 9, it is assumed that the server 30 has acquired the position and the usage status of the locker.

As illustrated in FIG. 9, as intention of using reception determination processing (S30), the server communication unit 31 of the server 30 determines whether or not the user agrees to use the autonomous driving locker. This processing is the same as the reception determination processing (S22) in FIG. 7.

When it is determined that the user agrees to use the autonomous driving locker (YES in S30), as priority order determination processing (S32), the entire locker management unit 32 determines whether or not the information indicating that the deposit of the luggage is prioritized is received. In the screen example G7 (FIG. 8A), when the icon of the deposit priority button or the pickup time priority button is selected by user, the user device 10 transmits information on the selected icon to the server 30. When information indicating, that the deposit priority button is selected is received, the entire locker management unit 32 determines that the information indicating that the deposit of the luggage is prioritized is received.

When it is determined that the information indicating that the deposit of the luggage is prioritized is received (YES in S32), as autonomous driving locker information presentation processing (S34), the entire locker management unit 32 presents the information on the empty autonomous driving locker. This processing is the same as the information presentation processing (S24) in FIG. 7, and the screen example G6 (FIG. 6C) is presented to the user. The constraint on the pickup (pickup time and deposit duration) is displayed as illustrated in screen example G6.

When it is determined that the information indicating that the deposit of the luggage is prioritized is not received (NO in S32), as desired pickup condition reception processing (S40), the entire locker management unit 32 acquires the pickup position and time from the user device 10. As illustrated in screen example G7 (FIG. 8A), since there are only two choices as an example, the case where the information indicating that the deposit of the luggage is prioritized is not received is the case where the information indicating that the pickup time priority button is selected is received. In this case, the user device 10 displays the screen example G8 (FIG. 8B) and receives the pickup position and time input by the user. The user device 10 transmits the received information to the server 30. In this way, the entire locker management unit 32 receives the desired pickup condition.

Subsequently, as candidate presentation processing (S42), the entire locker management unit 32 selects the vehicle 2 satisfying the desired pickup condition or the vehicle 2 close to the desired pickup condition, and presents the result to the user. For example, the entire locker management unit 32 creates a list of the candidate autonomous driving lockers, and transmits the list to the user device 10.

When the autonomous driving locker information presentation processing (S34) or the candidate autonomous driving locker information presentation processing (S42) ends, the reservation reception determination processing (S36) and the reservation processing (S38) are performed. Those processes items are the same as the reservation reception determination processing (S16) and the reservation processing (S18) in FIG. 7.

When it is determined that the user does not agree to use the autonomous driving locker (NO in S30), when the reservation processing (S38) ends, or when it is determined that the reservation is not received (NO in S36), the flowchart in FIG. 9 ends. Then, a series of locker reservation processing items ends.

### Summary of Second Embodiment

The server 30 changes the presented information according to the usage mode selected by the user, and then, dispatches the vehicle 2. Therefore, it is possible to further improve the convenience of the user's luggage deposit.

### Third Embodiment

A locker management system in a third embodiment is different from the locker management system 1 in the first embodiment in a point that a constraint condition for the autonomous driving locker is presented to user, and when the condition is agreed, it is regarded that the reservation is made, and others are the same as that in the first embodiment. In the third embodiment, the description on processing using the release code will be disclosed in detail.

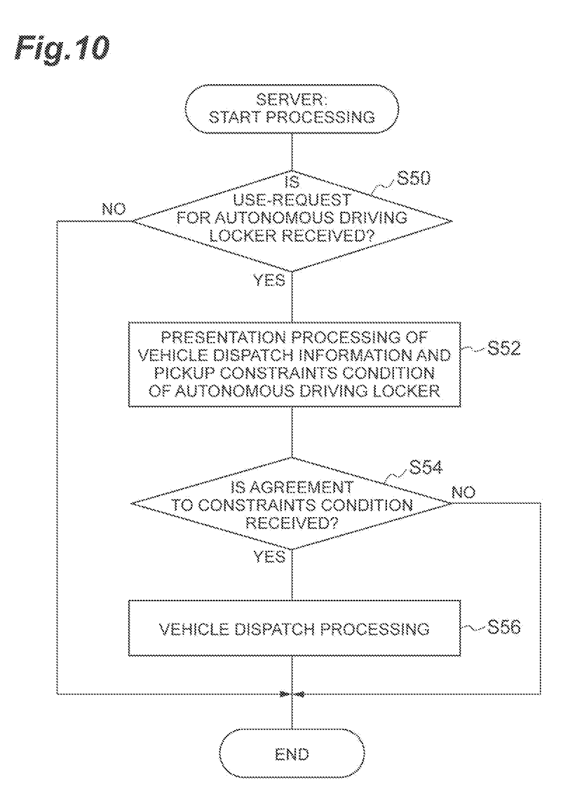

FIG. 10 is a flowchart illustrating an example of reservation processing. The flowchart in FIG. 10 is executed by the server 30. The flowchart in FIG. 10 is executed, for example, at the timing when the user device 10 and the server 30 are in the activation state and when the user activates the luggage deposit application of the user device 10, a the WEB screen of the luggage deposit service, and the like. Before the start of the flowchart in FIG. 10, it is assumed that the server 30 has acquired the position and the usage status of the locker.

As illustrated in FIG. 10, as intention of using reception determination processing (S50), the entire locker management unit 32 of the server 30 determines whether or not the use-request for the autonomous driving locker is received from the user.

When it is determined that the use-request for the autonomous driving locker is received from the user (YES in S50), as presentation processing (S52), the entire locker management unit 32 presents the vehicle dispatch information and pickup constraints condition of the autonomous driving locker to the user. The entire locker management unit 32 displays the vehicle dispatch information of the autonomous driving locker, the pickup constraints condition, and a selection button as to whether or not to agree on the user device 10.

Subsequently, as determination processing (S54), the entire locker management unit 32 determines whether or not the information indicating that the user agrees to the pickup constraints condition is received.

When it is determined that the information indicating that the user agrees to the pickup constraints condition is received (YES in S54), as vehicle dispatch processing (S56), the entire locker management unit 32 transmits the release code and causes the vehicle dispatch control unit 33 to dispatch the vehicle 2 presented to the user.

When it is determined that the use-request for the autonomous driving locker is not received (NO in S50), when it is determined that the information indicating that the user does not agree to the pickup constraints condition is received from the user (NO in S54), or when the vehicle dispatch processing (S56) ends, the flowchart illustrated in FIG. 10 ends. Then, a series of locker reservation processing items ends.

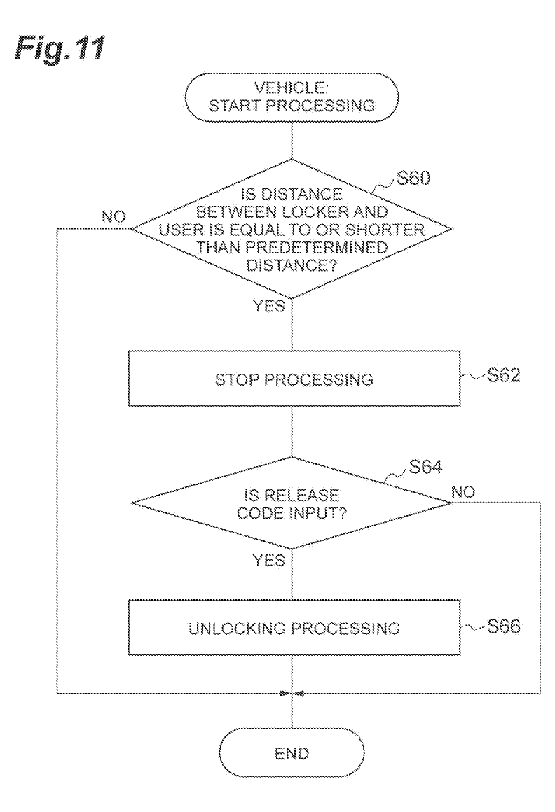

FIG. 11 is a flowchart illustrating an example of luggage reception processing. The flowchart in FIG. 11 is executed by the vehicle 2. The flowchart in FIG. 11 starts, for example, after the execution of the flowchart in FIG. 10.

As illustrated in FIG. 11, as arrival determination processing (S60), the autonomous driving unit 23 of the vehicle 2 determines whether or not a distance between the position of the vehicle 2 and the position of the user is equal to or shorter than a predetermined distance. When it is determined that the distance to the user is equal to or shorter than the predetermined distance (YES in S60), as stop processing (S62), the autonomous driving unit 23 stops the vehicle 2.

Subsequently, as unlocking determination processing (S64), the vehicle 2 determines whether or not the user inputs the release code. When it is determined that the release code is input (YES in S64), the locker management unit 24 of the vehicle 2 collates the release code acquired from the server 30 with the release code input by the user. When it is determined that the release codes are the same, as unlocking processing (S66), the locker management unit 24 unlocks the locker.

When it is determined that the distance to the user is not equal to nor shorter than the predetermined distance (NO in S60), or when it is determined that the release code is not input (NO in S64), or when the unlocking processing (S66) ends, the flowchart illustrated in FIG. 11 ends. Then, a series of luggage reception processing items ends.

### Summary of Third Embodiment

The server 30 can secure the security of the deposited luggage by using the release code.

### Fourth Embodiment

A locker management system in a fourth embodiment is different from the locker management system 1 in the first embodiment in a point that whether or not to dispatch the autonomous driving locker is determined based on the number of fixed type lockers in use, and others are the same as that in the first embodiment.

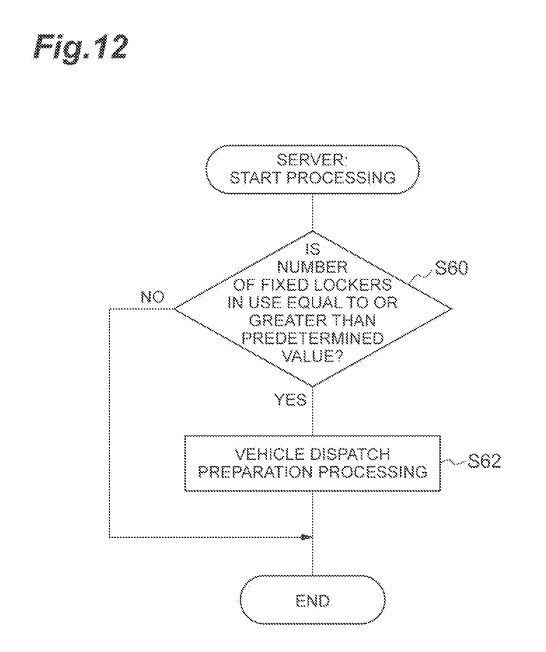

FIG. 12 is a flowchart illustrating an example of vehicle dispatch processing. The flowchart in FIG. 12 is executed by the server 30. Before the start of the flowchart in FIG. 12, it is assumed that the server 30 has acquired the position and the usage, status of the locker.

As illustrated in FIG. 12, as the number of fixed lockers in use determination processing (S60), the entire locker management unit 32 of the server 30 determines whether or not the number of fixed lockers in use is equal to or greater than a predetermined value.

When it is determined that the number of fixed lockers in use is equal to or greater than the predetermined value (YES in S60), as vehicle dispatch preparation processing (S62), the entire locker management unit 32 causes the vehicle dispatch control unit 33 to prepare for dispatching the vehicle. This is because there is a possibility that number of empty fixed type lockers may be insufficient, and thus, the autonomous driving locker may be used. Specifically, the vehicle dispatch control unit 33 makes the vehicle 2 start from a garage or the like.

When it is determined that the number of fixed lockers in use is not equal to nor greater than the predetermined value (NO in S60), or when the vehicle dispatch preparation processing (S62) ends, the flowchart illustrated in FIG. 12 ends. Then, a series of vehicle dispatch processing items ends.

### Summary of Fourth Embodiment

The server 30 prepares for the preparation of the autonomous driving locker according to the usage status of the fixed type lockers. Therefore, it is possible to quickly deliver the autonomous driving locker to the user.

### Fifth Embodiment

A locker management system in a fifth embodiment is different from the locker management system 1 in the first embodiment in a point that the navigation information is presented to the user when the autonomous driving locker exists near the user, and others are the same as that in the first embodiment. The navigation information is route guidance information on the map.

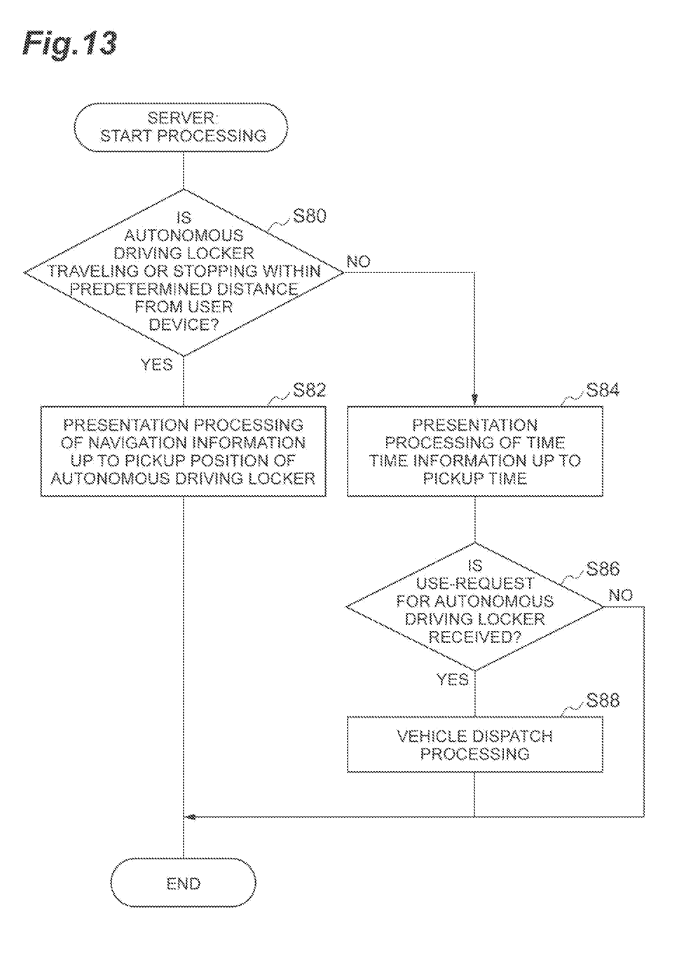

FIG. 13 is a flowchart illustrating an example of vehicle dispatch processing. The flowchart in FIG. 13 is executed by the server 30. The flowchart in FIG. 13 is executed, for example, at the timing when the user device 10 and the server 30 are in the activation state and when the user activates the luggage deposit application of the user device 10, a WEB screen of the luggage deposit service, and the like. Before the start of the flowchart in FIG. 13, it is assumed that the server 30 has acquired the position and the usage status of the locker.

As illustrated in FIG. 13, as autonomous driving locker position determination processing (S80), the entire locker management unit 32 of the server 30 determines whether or not the position of the autonomous driving locker is within a predetermined distance from the current position of the user device 10.

When it is determined that the position of the autonomous driving locker is within the predetermined distance from the current position of the user device 10 (YES in S80), as guidance presentation processing (S82), the entire locker management unit 32 presents navigation information up to the pickup position of the autonomous driving locker to the user.

When it is determined that the position of the autonomous driving locker is not within the predetermined distance from the current position of the user device 10 (NO in S80), as time presentation processing (S84), the entire locker management unit 32 presents the time to pickup to the user.

Subsequently, as reception determination processing (S86), the entire locker management unit 32 determines whether or not the use-request for the autonomous driving locker is received from the user. This processing is the same as the reception determination processing (S50) in FIG. 10.

When it is determined that the use-request for the autonomous driving locker is received from the user (YES in S86), as vehicle dispatch processing (S88), the entire locker management unit 32 causes the vehicle dispatch control unit 33 to dispatch the vehicle 2.

When the guidance presentation processing (S82) ends, when it is determined that the use-request for the autonomous driving locker is not received from the user (NO in S86), or when the vehicle dispatch processing (S88) ends, the flowchart illustrated in FIG. 13 ends. Then, a series of vehicle dispatch processing items ends.

### Summary Fifth Embodiment

When the autonomous driving locker exists near the user, the server 30 presents the guidance display to the user, and can prompt the user to come to the pickup position of the autonomous driving locker.

### Sixth Embodiment

A locker management system in a second embodiment is different from the locker management system 1 in the sixth embodiment in a point that, when the autonomous driving locker exists near the user, the position of the autonomous driving locker is presented to the user, and further, the user is inquired whether or not the autonomous driving locker is required to be move, and others are the same as that in the first embodiment.

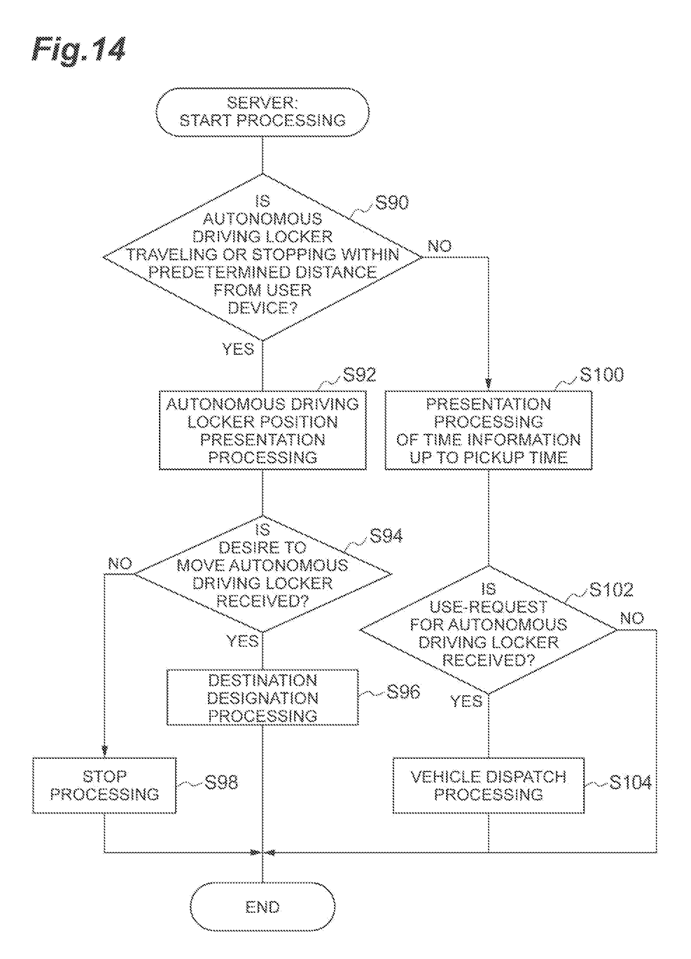

FIG. 14 is a flowchart illustrating an example of the vehicle dispatch processing. The flowchart in FIG. 14 is executed by the server 30. The flowchart in FIG. 14 is executed, for example, at the timing when the user device. 10 and the server 30 are in the activation state and when the user activates the luggage deposit application of the user device 10, a the WEB screen of the luggage deposit service, and the like. Before the start of the flowchart in FIG. 14, it is assumed that the server 30 has acquired the position and the usage status of the locker.

As illustrated in FIG. 14, as autonomous driving locker position determination processing (S90), the entire locker management unit 32 of the server 30 determines whether or not the position of the autonomous driving locker is within a predetermined distance from the current position of the user device 10.

When is determined that the position of the autonomous driving locker is within a predetermined distance from the current position of the user device. 10 (YES in S90), as guidance presentation processing (S92), the entire locker management unit 32 presents the position of the autonomous driving locker to the user.

Subsequently, as movement desire determination processing (S94), the entire locker management unit 32 determines whether or not a desire to move the autonomous driving locker is received from the user. The entire locker management unit 32 inquires of the user whether or not it is desirable to move the autonomous driving locker via the user device 10.

When it is determined that the desire to move the autonomous driving locker is received (YES in S94), as destination designation processing (S96), the entire locker management unit 32 inquires of the user about the destination of the movement via the user device 10. The entire locker management unit 32 receives the destination from the user device 10 and outputs the destination to the vehicle dispatch control unit 33. The vehicle dispatch control unit 33 directs the vehicle 2 toward the destination specified by the user.

When it is determined that the desire to move the autonomous driving locker is not received (NO in S94), as stop processing (S98), the entire locker management unit 32 outputs a message to stop the vehicle 2 to the vehicle dispatch control unit 33. The vehicle dispatch control unit 33 stops the vehicle 2.

When is determined that the position of the autonomous driving locker is not within the predetermined distance from the current position of the user device 10 (NO in S90), as time presentation processing (S100), the entire locker management unit 32 presents the time to pickup to the user.

Subsequently, as reception determination processing (S102), the entire locker management unit 32 determines whether or not the use-request for the autonomous driving locker is received from the user. This processing is the same as the reception determination processing (S50) in FIG. 10.

When it is determined that the use-request for the autonomous driving locker is received from the user (YES in S102), as vehicle dispatch processing (S104), the entire locker management unit 32 causes the vehicle dispatch control unit 33 to dispatch the vehicle 2.

When the destination designation processing (S96) ends, when the stop processing (S98) ends, when it is determined that the use-request for the autonomous driving locker is not received from the user (NO in S102), or when the vehicle dispatch processing (S104) ends, the flowchart illustrated in FIG. 14 ends. Then, a series of vehicle dispatch processing items ends.

### Summary of Sixth Embodiment

When the autonomous driving locker exists near the user, the server 30 can present the position of the autonomous driving locker to the user and can inquire of the user whether or not the autonomous driving locker is required to be moved. Therefore, it is possible to further improve the convenience.

### Seventh Embodiment

A locker management system in a second embodiment is different from the locker management system 1 in the seventh embodiment in a point that, when the use-request for the autonomous driving locker is received, it is determined whether or not the pickup is available and the information to be presented to user is changed according to the result of determination, and others are the same as that in the first embodiment.

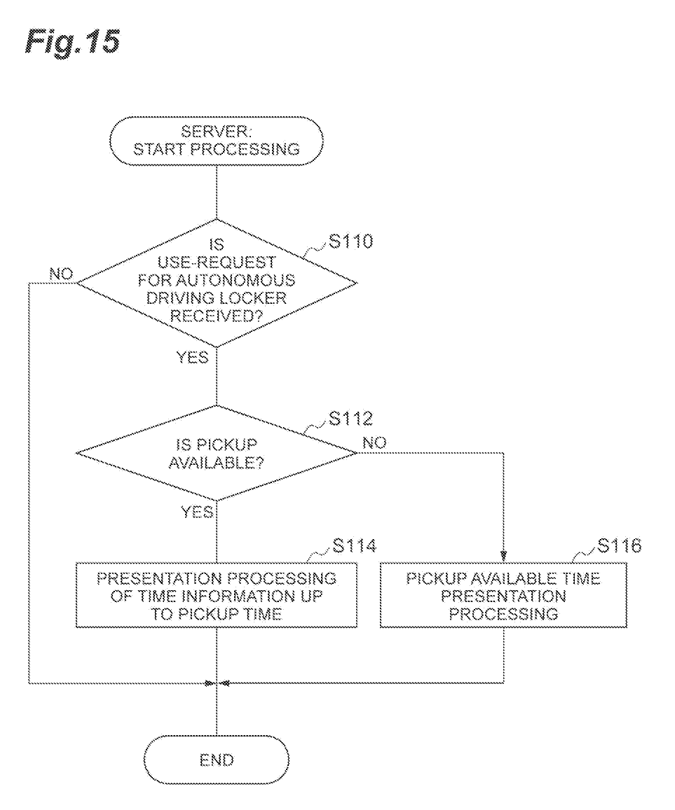

FIG. 15 is a flowchart illustrating an example of the vehicle dispatch processing. The flowchart in FIG. 15 is executed by the server 30. The flowchart in FIG. 15 is executed, for example, at the timing when the user device 10 and the server 30 are in the activation state and when the user activates the luggage deposit application of the user device 10, a the WEB screen of the luggage deposit service, and the like. Before the start of the flowchart in FIG. 15, it is assumed that the server 30 has acquired the position and the usage status of the locker.

As illustrated in FIG. 15, as reception determination processing (S110), the entire locker management unit 32 of the server 30 determines whether or not the use-request for the autonomous driving locker is received from the user. This processing is the same as the reception determination processing (S50) in FIG. 10.

When it is determined that the use-request for the autonomous driving locker is received from the user (YES in S110), the entire locker management unit 32 determines whether or not the pickup is available (S112). For example, when the position of the autonomous driving locker is within a predetermined distance from the current position of the user device 10, the entire locker management unit 32 determines that the pickup is available.

When it is determined that the pickup is available (YES in S112), as time presentation processing (S114), the entire locker management unit 32 presents the position and time of pickup to the user.

When it is determined that the pickup is not available (NO in S110), as time presentation processing (S116), the entire locker management unit 32 presents the time to pickup to the user.

When the time presentation processing (S114) ends, when the time presentation processing (S116) ends, or when it is determined that the use-request for the autonomous driving locker is not received from user (NO in S110), the flowchart illustrated in FIG. 15 ends. Then, a series of vehicle dispatch processing items ends.

### Summary of Seventh Embodiment

The server 30 can present whether or not the pickup is available soon to the user.

The embodiments described above can be implemented in various forms in which various modifications and improvements are made based on knowledge of those skilled in the art.

The locker management system 1 does not need to include a plurality of user devices and a plurality of vehicles, and may include only one user device and one vehicle.

In the examples, the vehicle 2 and the user device 10 are connected to the server 30 via the same network N, but may be connected to the server 30 via networks different from each other.

The locker management system 1 does not need to include the fixed type lockers 3A, . . . , 3X. In this case, the server 30 manages only the autonomous driving lockers. Even in such a case, the locker management system 1 can improve the convenience of the user's luggage deposit.

The locker management system 1 may be a system in which a plurality of systems are integrated. For example, the locker management system 1 may be a system in which a first system that includes a plurality of user devices 10A, . . . , 10X and the server 30, and a second system that includes a vehicle dispatch server and a plurality of vehicles 2A, 2B, . . . , 2X, are integrated, or may be a system in which a system configured with a plurality of user devices 10A, . . . , 10X, a system configured with the server 30, and a system configured with a plurality of vehicles 2A, 2B, . . . , 2X, are integrated.

What is claimed is:

1. A locker management device comprising:
a management unit configured to manage a usage status of lockers provided in an autonomous driving vehicle;
an acquisition unit configured to acquire a user's use-request for the locker; and
a vehicle dispatch control unit configured to dispatch the autonomous driving vehicle to a user,
wherein the management unit is configured to determine the locker to be used by the user based on the usage status of the lockers and the use-request acquired by the acquisition unit, and
wherein the vehicle dispatch control unit is configured to dispatch the autonomous driving vehicle provided with the locker determined by the management unit to the user.

2. The locker management device according to claim 1,
wherein the management unit provides the user who will use the locker with a release code for releasing a locking of the locker.

3. The locker management device according to claim 1,
wherein the management unit manages the locker, a locker capacity, and the usage status of the lockers in association with each other, and determines the locker to be used by the user based on the locker capacity, the usage status of the lockers, and the use-request acquired by the acquisition unit.

4. The locker management device according to claim 2,
wherein the management unit manages the locker, a locker capacity, and the usage status of the lockers in association with each other, and determines the locker to be used by the user based on the locker capacity, the usage status of the lockers, and the use-request acquired by the acquisition unit.
